(19) United States
(12) Patent Application Publication
(10) Pub. No.: US 2008/0291179 A1
(43) Pub. Date: Nov. 27, 2008

(54) Light Pen Input System and Method, Particularly for Use with Large Area Non-Crt Displays

(75) Inventors: Oscar Willemsen, Den Bosch (NL); Vincentius Paulus Buil, Eindhoven (NL); Marcellinus Petrus Carolus Michael Krijn, Eindhoven (NL); Galileo June Destura, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/095,026

(22) PCT Filed: Nov. 21, 2006
(86) PCT No.: PCT/IB06/54359

§ 371 Date: May 27, 2008

(30) Foreign Application Priority Data
Nov. 30, 2005 (EP) 05111499.9

(51) Int. Cl. G06F 3/037

(52) U.S. Cl. 345/180

(57) ABSTRACT

The invention relates to a light pen input system with a light pen which is adapted to generate at least one scanning light line sweep for scanning a surface such as for example a display screen. The time from starting a scan until a light sensing element placed at a known position detects a scanning light line is measured and processed for determining the coordinates of the pointing position of the light pen. Thus, an “inverse” light pen is provided which may be implemented at low costs and which may be used with non-CRT displays. Furthermore, the system is independent of the display screen size.

The invention relates to a light pen user interface technology which may be used with large area non-CRT displays.

A traditional light pen is an input device which comprises a light sensor for detecting light emitted from a cathode ray tube (CRT) display. The light pen technology is nowadays mostly used in gaming arcades as input device, for example as a gun. A light pen is connected with a computer, for example by a wire, and comprises a switch for inducing an action to be performed by the computer, for example for firing shots in a video game. When an activation of the switch is detected by the computer, the scan time of the electron beam inside a CRT display tube from the starting point of the electron beam on the screen until the light sensor detects light is measured. Since the “way” of the electron beam on the screen and the coordinates of its starting point are known, the horizontal and vertical position of the light pen pointer on the display screen may be calculated from the measured time. In this technology, the display serves as light emitter and the light pen as receiver. This technology requires a raster-scanned display such as a CRT display. However, it does not work with modern non-CRT display technologies such as the liquid crystal display (LCD), thin film transistor (TFT) or plasma display technology. EP 0 786 107 B1 discloses a light pen input system which can be used with a LCD display. The disclosed system comprises a light sensing device with a planar array of light sensing elements in rows and columns. However, the required light sensing elements make the system costly to implement.

It is an object of the present invention to provide an improved light pen input system and method, particularly for use with large area non-CRT displays.

In order to achieve the object defined above, the invention provides a light pen input system, wherein the system comprises the following characteristic features:

a light pen being adapted to generate at least one scanning light line sweep for scanning a surface,

a light sensing element placed at a known position for detecting a scanning light line,

time measurement means being adapted to measure a time duration t−tₛₜₐᵣₜ from receiving a scanning start signal until receiving a light detection signal from the light sensing element, and

position detection means being adapted to determine the coordinates of the pointing position of the light pen with regard to the surface from measured time durations t−tₛₜₐᵣₜ.

In order to achieve the object defined above, the invention further provides a method for determining the pointing position of a light pen, wherein the method comprises the following characteristic features:

the light pen generates at least one light line sweep for scanning a surface,

a light sensing element placed at a known position detects a scanning light line,

time measurement means measure a time duration t−tₛₜₐᵣₜ from receiving a scanning start signal until receiving a light detection signal from the light sensing element, and position detection means determine the coordinates of the pointing position of the light pen with regard to the surface from measured time durations t−tₛₜₐᵣₜ.

The characteristic features according to the invention provide the advantage that the invention may be used with non-CRT displays, particularly large area non-CRT displays such as liquid crystal displays (LCD), thin film transistor (TFT) or plasma displays. In principle, the invention is display independent. Furthermore, the invention does not require several light sensing elements arranged in an array with rows and columns as known from EP 0 786 107 B1 and, therefore, may be implemented at low cost. On the light receiving side, i.e. on the surface or display side, the invention merely requires at least one light sensing element placed at a known position, for example located at a border of a surface such as a display screen. Furthermore, the invention makes the interaction with a large area display by pointing much easier than with the traditional light pen technology since it does not require to point inside the borders of a display screen or of a light sensing device. Thus, the invention is principally independent from the size of a display screen. It may be used either with large area or small area display screens since the determination of the pointing position of the light pen is in principle independent from pointing inside or outside the display screen. If a user points outside a surface such as a large area display screen, the pointing position may also be detected by the system according to the invention and, for example, mapped back as a “mouse pointer” movement on the screen. Thus, users do not have to point so precisely, which increases the ease of operation, particularly with large area display screens. It should be noted that a display is not a prerequisite for this invention. The invention is suitable for consumer electronics, industrial, military, and medical applications as a pointing, orientation and positioning method in general. When used with consumer electronics applications, the invention is suitable to be implemented on existing remote controls and electronic systems such as TV systems.

It should be noted that the term “light pen” means a pointing device which emits light in contrast to traditional light pens which receive light emitted from a CRT display.

The term “scanning light line” used herein should be understood as a line of light projected on a surface similar to a light line generated by a typical barcode scanner.

The term “scanning light line sweep” means that the light line scans a predefined area when projected on the surface, i.e., a light line scan is moved in a certain direction over the predefined area in order to scan the area. In case of two scanning light lines for scanning the predefined area in two different directions, the scanning light lines may be moved in an orthogonal direction with respect to each other over the predefined area. Thus, the predefined area may be scanned for example in a horizontal and a vertical direction.

A “sweep” means moving the scanning light line from a scan starting position to a scan end position. The scan start and end position of the line determine the predefined area to be scanned.

The term “light sensing device” comprises any device sensitive to light emitted by the light pen such as photo detectors or photodiodes.

The term “position detection means” comprises any means able to determine the pointing position of the light pen. Particularly, the position detection means comprise an algorithm for calculating the pointing position from the time durations measured by the time measurement means. This algorithm may be adapted to calculate the distance of the pointing position of the light pen with regard to the surface, i.e., the x- and y-coordinates of the pointing position in the plane of the surface from the time durations measured by the time measurement means. The x- and y-coordinates may be calculated from the measured time durations and the known velocity of the sweeps of scanning light lines over the surface. It should be noted that the mentioned algorithm may be implemented in soft- or hardware.

The term “pointing position” may be explained by the position of an intersection of the pointing axis of a light point and the plane of the surface when the light pen is directed to the surface similar to the spot generated by a laser pointer pointing on a surface.

The coordinates of the pointing position are the two-dimensional Cartesian coordinates in the plane of the surface, i.e., the x- and y-coordinate of a point in the plane of the surface.

The basic idea of the invention is detecting a pointing position of a light pen with regard to a surface in that the light pen scans a predetermined area with at least one scanning light line and the time duration from starting a scan until detecting light at a certain and known position on the border of the surface is measured. With this information and few further known parameters such as the time duration of an entire sweep or the coordinates of the light sensing element in the plane of the surface, the x- and y-coordinates of the pointing position of the light pen may be determined.

With one scanning light line sweep, the surface may be scanned in one direction, and the position detection means may determine a coordinate of the pointing position in the sweep or scanning direction. In order to determine two coordinates in the plane of the surface, the light pen may be adapted to generate two scanning light line sweeps for scanning the surface in two different directions. Thus, the pointing position of the light pen may be determined with a higher accuracy than with one scanning light line sweep. The two scanning light lines generated by the light pen may have different wavelengths which allows a simultaneous scanning of the surface. This may be faster than a serial scanning with two scanning light lines having the same wavelength.

Since the invention may be preferably applied to display screens, the surface has usually a rectangular shape. Thus, it is preferred if one of the two scanning light lines is moved in a first direction, and the other one of the two scanning light lines is moved in a second direction which is orthogonal to the first direction. Thus, the surface may be scanned in a horizontal direction by one of two scanning light lines and in a vertical direction by the other one of the two scanning light lines.

Preferably, each of the two moving directions of the scanning light lines corresponds to a coordinate in the two-dimensional coordinate system of the plane of the surface. For example, the first direction may be used to determine the x-coordinate of the pointing position and the second direction may be used to determine the y-coordinate. In order to determine these coordinates, the position detection means may be adapted to determine a x-coordinate of the pointing position of the light pen from a measured time duration tx−txₛₜₐᵣₜ triggered from the scanning light line sweep in the first direction and a y-coordinate of the pointing position of the light pen on the surface from a measured time duration ty−tyₛₜₐᵣₜ triggered from the scanning light line sweep in the second direction.

The light pen input system according to the invention may also be used to determine movements of the light pen, i.e., when the light pen position changes from one to another position due to a movement of the light pen, for example when the light pen is used to control a cursor of a graphical user interface shown on a display screen. For performing this task, the position detection means may be adapted to determine a movement of the light pen from at least two consecutive measured time durations t0−t0ₛₜₐᵣₜ and t1−t1ₛₜₐᵣₜ. The two consecutive measured time durations may correspond to two scans. Therefore, when the second scan starts after the first scan and the position of the light pen has changed, the second measured time duration corresponding to the second scan differs from the first measured time duration. Since the time durations correspond to the pointing position, this means that the distance between the light pen position and the light sensing element has changed. The difference of the distances derived from the two measured time durations may then be mapped to a corresponding movement of the light pen.

In order to accurately determine the pointing position, the light pen may be adapted so that the time duration of a scanning light line sweep is about 5 to 10 milliseconds. This means that a scan in each direction performed by the light pen takes about 5 to 10 milliseconds. Usually, this time is so short that it is unlikely that a user moves the light pen within a shorter time and the determined pointing position is inaccurate. However, it should be noted that the time duration of a scanning light line sweep may be selected from a time range from about 1 to about 100 ms, wherein a short time duration has the advantage that movements of the light pen may be detected faster than with a long time duration.

The determination of the pointing position of the light pen may be simplified if the angular velocity of movement of a generated scanning light line is nearly constant and/or predefined. For example, the distances corresponding to the measured time durations can be calculated by multiplying the time durations with the known velocity of movement of a scanning light line.

For detecting a skew of the light pen, for example if a user rotates the light pen such that the surface is not scanned in a horizontal and vertical direction, a second light sensing element being aligned to the first light sensing element may be provided for detecting skew. The time measurement means may be further adapted to measure a first time duration t1−t1ₛₜₐᵣₜ from receiving a scanning start signal until receiving a light detection signal from the first light sensing element and a second time duration t2−t2ₛₜₐᵣₜ from receiving the scanning start signal until receiving a light detection signal from the second light sensing element, and the position detection means may be adapted to determine a skew of the light pen with regard to the surface from the first and second measured time durations.

Preferably, the surface has a rectangular or quadratic shape. In such a case, both light sensing elements may be located in opposite corners of the surface and the position detection means may be further adapted to determine the size of the surface from the first and second measured time durations, to store the determined size, and to use the determined size for the determination of the coordinates of the pointing position of the light pen with regard to the surface.

The light sensing element may be located at a border or corner of the surface, integrated into, located underneath, besides or in front of the surface. It should be located such that it is within the scanning range of a scanning light line sweep when a user points with the light pen at or near the surface in order to determine the pointing position.

According to a further aspect, the invention relates to a light pen being adapted for use with a light pen input system according to any of the before discussed embodiments, wherein the light pen comprises at least one laser and optical means for generating two scanning light lines.

According to an embodiment of the light pen, it may comprise two lasers capable of generating laser beams with different wavelengths. Instead of two lasers, the light pen may also comprise one laser and the optical means may comprise a beam splitter for splitting the laser beam generated by the laser into two laser beams.

According to an embodiment of the light pen, the optical means may comprise a first barrel lens for creating a vertical scanning light line, a second barrel lens for creating a horizontal scanning light line, a first movable mirror for sweeping the vertical scanning light line over a predefined area, and a second movable mirror for sweeping the horizontal scanning light line over a predefined area.

According to a further embodiment, the light pen may be adapted for transmitting a scanning start or synchronization signal to the time measurement means. The scanning start or synchronization signal may be transmitted either over a wire line or wireless connection to the time measurement means. For example, the light pen may be connected by a wire to a display screen unit comprising the time measurement means and the position detection means, or it may comprise a wireless module for communicating with a wireless module of the display screen unit and transmitting the scanning start signal over a wireless communication connection. For example, the scanning start signal may be transmitted by light to the timing measurement means, for example by an infrared light emitting diode contained in the light pen which generates a infrared pulse which is transmitted to an infrared receiver in a display screen unit comprising the time measurement means. It should be noted that the time measurement means do not necessarily be integrated in a display device. For example, it may also be implemented as a stand-alone box connectable to a computer or some other device that needs a coordinate input or gesture input (derived from a series of coordinate information). According to an alternative embodiment, the light pen may also be adapted to receive the scanning start or synchronization signal from the time measurement means or the position detection means. In such case, the scanning is initiated by the time measurement means or position detection means. The time measurement means and position detection means may be implemented as a stand alone unit which comprises a first interface for connecting with a computer or consumer electronics device such as a TV set and a second interface over which the scanning start or synchronization signal is sent out to the light pen.

The invention relates also to a display screen unit comprising a light pen input system according to any of the before discussed embodiments. The light pen input system may also be suitable to be used with multiple light pens according to embodiments of the invention. The multiple light pens may be discriminated by one system using, for example, different color frequencies per light pen.

The display screen unit may comprise a communication interface adapted for communicating with a light pen according to any of the before discussed embodiments of the light pen according to the invention.

The display screen unit may further comprise processing means for controlling the position of a cursor displayed on the display screen of the display screen unit based on the coordinates of the pointing position of the light pen determined by the position detection means of the light pen input system.

According to an embodiment of the display screen unit, the first light sensing element may be located at the border of the display screen and the unit may comprise the time measurement and position detection means.

Particularly, the invention is suitable to be used with any kind of flat panel display screens such as a LCD or TFT, plasma, OLED, LCOS display or even a display generated by a video projector. However, the invention may also be used without a display or display screen.

The invention finally relates to a bar which is adapted for use with a light pen input system according to any of the above discussed embodiments, wherein the bar comprises photodiodes on each edge for detecting a scanning light line. Such a bar may be used for example with a video projector. The bar may be placed on an edge of the projection area and used to detect the pointing position of a light pen on the projected display. This is helpful when a video projector is used to project a computer display and the light pen is used as input device for controlling for example a mouse pointer of the computer display.

These and other aspects of the invention will be apparent from and elucidated with reference to the embodiment(s) described hereinafter.

The invention will be described in more detail hereinafter with reference to exemplary embodiments. However, the invention is not limited to these exemplary embodiments.

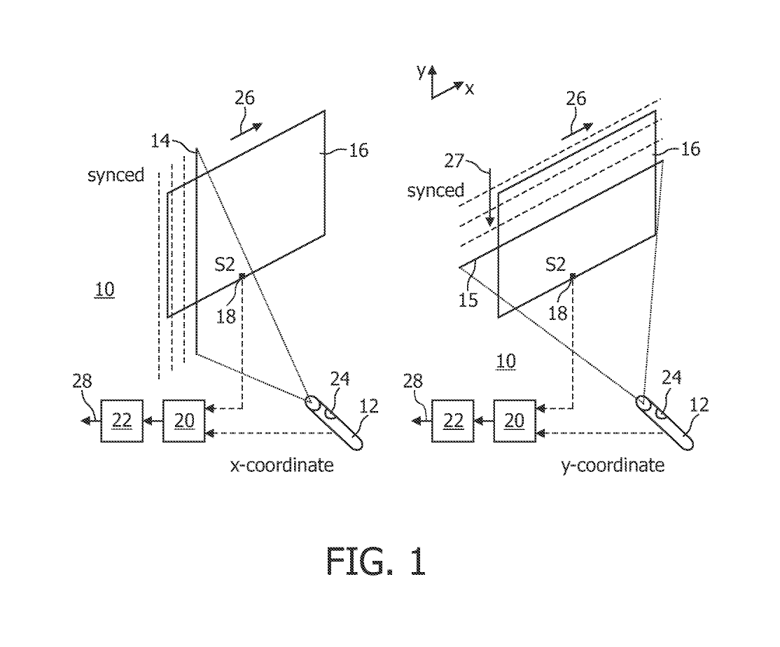

FIG. 1 shows the principle of scanning a display screen with a light pen according to the present invention;

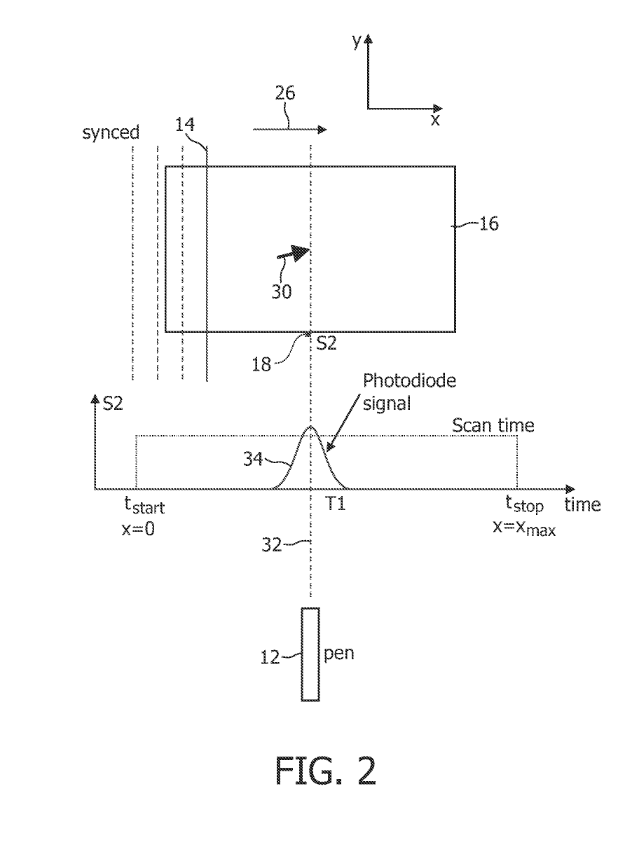

FIG. 2 shows s horizontal scan of a display screen with a light pen and the light detection signal generated by a photodiode located at the lower margin of the display screen according to the invention;

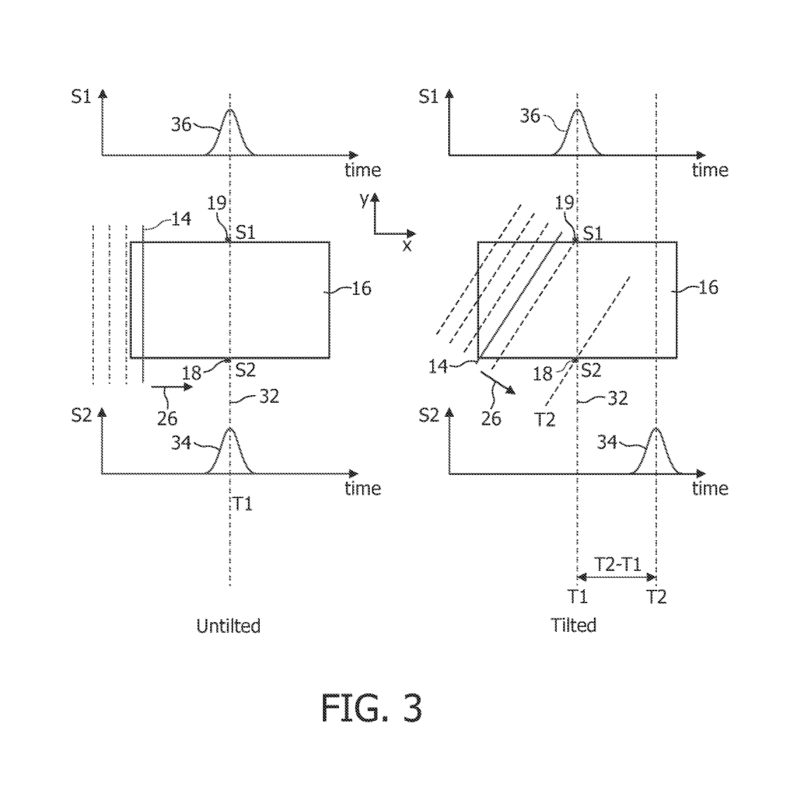

FIG. 3 shows the principle of detecting skew with a second photodiode located at the upper margin of the display screen according to the invention;

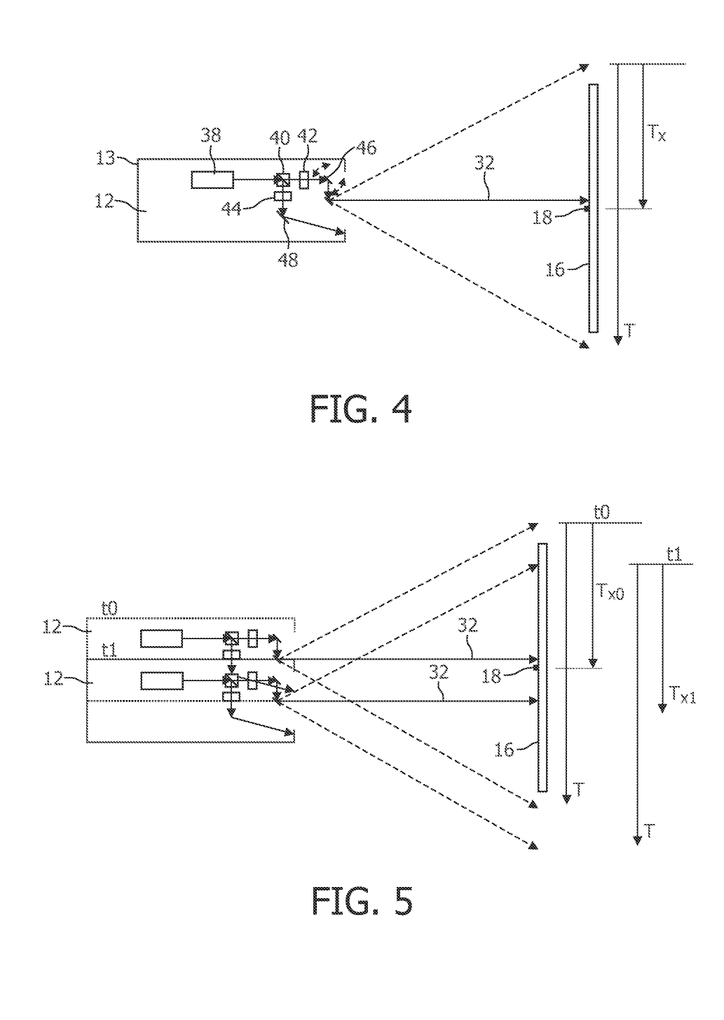

FIG. 4 shows an embodiment of the light pen according to the invention; and

FIG. 5 shows the determination of a movement of the light pen according to the invention.

In the following, functional similar or identical elements may have the same reference numerals.

FIG. 1 shows a first embodiment of a light pen input system 10 according to the invention. The system 10 is based on an “inverse” light pen technology and comprises a light pen 12 for generating scanning light line sweeps 14 and 15 in two different directions 26 and 27, a photodiode 18 (in FIG. 1 also marked as S2) serving as light sensing element for detecting a scanning light line, time measurement means 20 for measuring a time duration from the start of a scanning light line sweep and the detection of light by the photodiode 18, and position detection means 22 for determining the pointing position of the light pen 12 from the measured time durations. This light pen input system 10 allows, for example, to control a cursor of a graphical user interface (GUI) shown on a display screen 16 such as a computer or TV display screen.

The light pen 12 generates two scanning light lines 14 and 15 which are arranged orthogonal. Thus, the first scanning light line 14 is provided for scanning the display screen 16 in a first horizontal direction 26, as shown in the left picture of FIG. 1, while the second scanning light line 15 is provided for scanning the display screen 16 in a second vertical direction 27, as shown in the right picture of FIG. 1. Scanning in either one of the directions 26 and 27 is performed by moving the scanning light line 14 or 15, respectively, from a starting position to an end position, then moving it back to the starting position in order to be ready for a further scan of the display screen 16. The “fly-back” of the scanning light line 14 or 15 may be used to scan again the pointing position thereby doubling the position refresh rate. However, this requires that the “fly-back” is performed under predefined conditions, for example with identical parameters as the normal sweep. If for example the sweep is generated by using a scanning mirror in the light pen, this requires that the mirror does not have a hysteresis. Such a scanning method is herein called a sweep. Sweeping of the scanning light lines 14 and 15 is performed by optics contained in the light pen 12. The light pen 12 may perform continuously scanning light line sweeps, or only when activated, for example by pressing a scanning start button 24 on the light pen 12 or when receiving a scanning start or synchronization signal. In the latter case, a determination of the pointing position is only performed upon activation the scanning start button 24 of the light pen 12 or upon receipt of the scanning start or synchronization signal. The sweep of the scanning light line 14 in the first horizontal direction 26 may be carried out before the sweep of the scanning light line 15 in the vertical direction 27, or vice versa.

The photodiode 18 is provided as a light sensing element and located at the lower boundary of the display screen 16. The photodiode 18 generates a light detection signal if a scanning light line 14 or 15 is moved over it. The light detection signal and a scanning start signal generated by the light pen 12 are supplied to the time measurement means 20. The time measurement means 20 may be implemented by a counter which is started upon receipt of the scanning start signal (time tₛₜₐᵣₜ), and stopped upon receipt of the light detection signal (time t). The counting value corresponds to the time duration t−tₛₜₐᵣₜ and is transmitted to position detection means 22 which may be implemented by a processor programmed to determine the pointing position of the light pen 12 from the time duration t−tₛₜₐᵣₜ.

For determining the x-coordinate of the pointing position of the light pen 12, the first scanning light line 14 sweep is started. For synchronizing the whole system, a first scanning start signal is generated at time t1ₛₜₐᵣₜ, for example by the light pen 12 and transmitted to the time measurement means 20. The scanning start signal may also be generated by other components of the system, for example by the time measurement means 20 or the position detection means 22, or by a computer which generates and communicates a message like “you can start now” to the light pen 12. The scanning start signal triggers the counter of the time measurement means 20 to start counting. Then the scanning light line 14 is moved across the entire display screen 16 in the horizontal direction 26 at a constant rate, i.e., at a constant angular displacement rate or velocity. When the scanning light line 14 passes the photodiode 18, the photodiode 18 is illuminated for a certain time. Thus, the photodiode 18 generates a light detection signal and transmits it to the counter of the time measurement means 20. When the counter receives the light detection signal it stops counting at time t1. The counting value represents now the time duration Tx=t1−t1ₛₜₐᵣₜ from the start of the scanning light line 14 sweep and the light detection by the photodiode 18. The counting value is transmitted to the position detection means 22 which calculate the x-coordinate of the light pen's 12 pointing position from the counting value.

After finishing the first scanning light line sweep, the second scanning light line sweep in the vertical direction 27 is started. Again, for synchronizing the whole system 10, a scanning start signal is generated, for example by the light pen 12 and transmitted to the time measurement means 20 triggering the counter to start counting at time t2ₛₜₐᵣₜ. Then, the scanning light line 15 is moved over the entire display screen 16 in the vertical direction 27. When the scanning light line 15 illuminates the photodiode 18 by passing it, the photodiode 18 generates a light detection signal and transmits it to the counter triggering the counter to stop counting at time t2. The position detection means 22 receive the measured time duration Ty=t2−t2ₛₜₐᵣₜ from the time measurement means 20 and calculate from this time duration t2-t2ₛₜₐᵣₜ the y-coordinate of the light pen's 12 pointing position. It should be noted that the system described above may also be designed to be used by multiple light pens. Then, each light pen must be discriminated by the system, for example by using different color frequencies for each light pen. The photodiode or photodiodes used with a multiple light pen input system may then be sensitive to different wavelengths of received electromagnetic radiation, and generate different output signals depending on the wavelength of a received radiation in order to allow discriminating the light detection signals generated by a photodiode receiving electromagnetic radiation from a light pen.

In the following, it is explained how the x- and y-coordinates of the light pen's 12 pointing position may be calculated from the measured time durations Tx and Ty. If the angular velocity of the movement of the scanning light lines 14 and 15 is known and constant, and the distance of the light pen 12 from the display screen 16 is known, the time durations Tx and Ty, the distance between the light pen 12 and the display screen 16, and the angular velocity of the scanning light lines 14 and 15 may be used to calculate distances Δx and Δy. These are the distances between the starting point of each scanning light line sweep and the position of the photodiode 18. Thus, knowing the x- and y-coordinate of the location of the photodiode may be used to determine the starting point of the scanning light line sweeps. Another way to determine the x- and y-coordinates of the light pen's 12 pointing position is to calculate the fraction Tx/T and Ty/T with T is the time duration of an entire scanning light line sweep. The fractions can then be multiplied by the horizontal and vertical display size, respectively, in order to obtain the x- and y-position of a cursor on the display screen 16. A ratio, for example the ratio of the width and height of a display screen may be introduced by a scaling factor into the above formulas for determining the x- and y-coordinates. For example, such a scaling factor may be desirable to map large light pen movements onto smaller cursor movements on a display screen. This is one of the specific benefits of the present invention because it offers a user of the light pen input system to point in a larger area than the display screen area and, thus, makes the usage of the system easier.

For determining the distance between the light pen 12 and the display screen 16, a further photodiode (not shown) may be used. The output signal of this photodiode may depend on the light intensity of the laser light lines generated by the light pen 12. Thus, the distance may be determined by processing the output signal of this further photodiode. The determined distance between the light pen 12 and the display screen 16 may be processed as an additional input, for example for 3-dimensional applications controlled by the light pen 12.

The determined x- and y-coordinates of the pointing position of the light pen 12 may be transmitted as data 28 for further processing, for example by a computer or a display processor (not shown) which are programmed to display a GUI on the display screen. The computer or processor may use the x- and y-coordinates to control the display of a mouse pointer or a cursor of the GUI. It should be noted that the light pen input system 10 according to the invention may operate in an absolute mode and a relative mode. In the absolute mode, the measured time durations may be approximated to be directly proportional to the position assumed by a mouse pointer or cursor shown on the display screen 16. The start times t1ₛₜₐᵣₜ and t2ₛₜₐᵣₜ of the two scanning light line sweeps in horizontal and vertical direction may be mapped to the left and right location of the display screen 16. However, the system 10 may also be operated in a relative mode. In this mode, a first scanning light line sweep serves as a reference for following scanning light line sweeps. When time shifts are detected with the succeeding scanning light line sweeps, the pointing position of the light pen 12 has changed or—in other words—the mouse pointer or cursor was moved.

FIG. 2 shows an ideal case of using the light pen input system 10, wherein a user sits right in front of the display screen 16 and points with the light pen 12 in a direction normal to the plane of the display screen 16. As indicated in the time diagram with the signal of the photodiode 18 shown in FIG. 2, the scanning light line sweep starts at time tₛₜₐᵣₜ and stops a time tₛₜₒₚ. The start time tₛₜₐᵣₜ is mapped to a x-coordinate x=0 and the stop time tₛₜₒₚ to a x-coordinate xₘₐₓ. At time T1, the photodiode 18 detects an illumination by the scanning light line 14 and generates a light detection signal which may be a digital representation of the photodiode signal shown in the time diagram in FIG. 2. The time duration T1−tₛₜₐᵣₜ may be processed by the position detection means for determining the x-coordinate of a mouse pointer 30 which is displayed on the display screen 16. Furthermore, the mouse pointer 30 is moved in accordance with the determined x- and y-coordinates of the light pen's 12 pointing position on the display screen 16. In FIG. 2, the mouse pointer 30 is displayed at the intersection of the pointing axis 32 of the light pen 12 and the display screen 16.

In the ideal case as shown in FIG. 2, the light pen 12 is held by a user untilted, i.e., so that the scanning light line sweeps have a nearly horizontal and vertical direction 26 and 27, respectively, with regard to the display screen 16. However, under realistic conditions a user may hold the light pen 12 tilted so that the directions 26 and 27 are neither nearly horizontal nor vertical, as it is shown in the right picture of FIG. 3. The resulting skew influences the determination of the pointing position of the light pen 12, particularly the accuracy of the determination. In order to avoid an inaccurate determination of the pointing position due to such a skew, a second photodiode 19 (in FIG. 3 also marked as S1) as second light sensing element may be provided for determining skew. The second photodiode 19 is aligned with the first photodiode 18 in that it is located at the side of the display screen 16 opposite to the side where the first photodiode 18 is located at the display screen 16. Both photodiodes 18 and 19 are located on the ideal axis 32. The second photodiode 19 also generates a light detection signal when it is illuminated by a scanning light line. In FIG. 3, the photodiode signals 34 and 36 of the first and second photodiode 18 and 19, respectively, are shown in time diagrams below and above the display screen 16. It should be noted that both photodiodes may also be located at opposite corners of the display screen. In this case, a reference for determining the boundaries of the display screen is available. However, determining skewness is more difficult in this case (and not very well defined).

When the light pen 12 is held untilted, as it is the case in the left picture of FIG. 3, the photodiode signals 34 and 36 occur nearly at the same time. Thus, the first time duration between the start of the scanning light line sweep and the receipt of the first photodiode signal 34 and the second time duration between the start of the scanning light line sweep and the receipt of the second photodiode signal 36 do not differ significantly. The position detection means will note that the light pen 12 is held untilted and no skew occurs. However, when the photodiode signals 34 and 36 occur at different times T2 and T1, respectively, the first and second time durations differ significantly by the time difference T2-T1. This time difference T2−T1 may be detected by the position detection means and considered for determining the pointing position of the light pen 12. The time difference T2−T1 corresponds to the amount of skew. For example, if the time difference T2−T1 is positive, the light pen 12 is rotated towards the right. If the time difference T2−T1 is negative, the light pen 12 is rotated towards the left. From the time difference T2−T1, a distance may be calculated which may be used to calculate the angle of rotation and considered for compensating the inaccuracy of the determined pointing position due to the skew or angle of rotation. For an accurate compensation, the aspect ratio of the display screen 16 should be known.

It should be noted that a rotation of the light pen 12 may also be processed as further input data in addition to the pointing position. This feature may be of interest for 3-dimensional applications or 3d displays. For example, the rotation may be evaluated in a computer game as further input controlling the movement of a player. This functionality may be activated by a further rotation button of the light pen 12. When a user presses this rotation button and rotates the light pen 12, the resulting skew incurring the above explained time difference may be processed as a further input, for example by the position detection means. When releasing the rotation button again, the skew may be compensated by the position detection means as normal function of the light pen input system.

FIG. 4 shows an embodiment of the light pen 12 in detail. The housing 13 of the light pen 12 contains a laser diode 38 and optical means for generating two different scanning light lines from the laser beam generated by the laser diode 38. The laser beam of the laser diode 38 is split into two different beams with different optical paths by a beam splitter 40. Each optical path contains a barrel lens 42 and 44, respectively. One of the barrel lenses 42 is adapted to create a vertical scanning light line from the laser beam, and the other one of the barrel lenses 44 is adapted to create a horizontal scanning light line from the laser beam. For sweeping the scanning light lines over a predefined area, both optical paths comprise moving mirrors 46 and 48. Each of the moving mirrors 46 and 48 may be brought into a parking position, in which the scanning light line is “parked”, i.e., deflected by the mirror so that it does not disturb the other scanning light line. Instead of “parking position”, two lasers may be applied which generate laser beams with different wavelengths. Then, the two scanning light lines may be simultaneously handled by the system. The light pen 12 also comprises control means (not shown) for controlling the movement of the mirrors 46 and 48 and the operation of the laser diode 38. The control means may be implemented by a microcontroller which is programmed so that it first brings the mirror 48 into the parking position and swings the mirror 46 to generate a first horizontal scanning light line sweep over the display screen 16, and then it the brings the mirror 46 into a parking position and swings the mirror 48 to generate a second vertical scanning light line sweep over the display screen 16. This process may be repeated until the light pen 12 is switched off, i.e., power of the light pen 12 is switched off.

Now, it will be explained how a movement of a cursor controlled by the light pen 12 may be determined. FIG. 5 shows a light pen 12 hold in a first position at time t0, and then hold in a second position, which differs from the first position, at time t1. The pointing axis 32 and the area scanned by a scanning light line sweep of the light pen 12 is moved together with the movement of the light pen 12. On the right hand side of FIG. 5, the time durations measured by the time measurement means during scanning light line sweeps are shown. In the first position, a time duration Tx0−t0 is measured, while in the second position, a shorter time duration Tx1−t1 is measured because the light pen 12 is moved closer to the middle point of the display screen 16.

The cursor x-position for the first position of the light pen 12 may be calculated as follows: cursor x0-position=Tx0/T*horizontal display size. The cursor x-position for the second position of the light pen 12 may be calculated as follows: cursor x1-position=Tx1/T*horizontal display size. These formulas only deliver accurate results if the scan size is equal to the display screen size. The horizontal and vertical screen size may be determined using two photodiodes located in opposite corner of the display screen 16 as described above. From these measurements, the absolute x- and y-coordinates of the pointing position of the light pen 12 may then be deduced. The cursor may be moved in accordance with the calculated x-position. It should be noted that a scanning light line sweep may be so fast, i.e., the total sweep time (addition of time durations of both sweeps) may be preferably only about 5 to 10 milliseconds that it is unlikely that a user moves the light pen 12 within this short time period. Thus, inaccurate measurements according to user movements during a sweep may be neglected.

The invention has the main advantages that it may be implemented at low costs and is display-independent, i.e., may be used with modern flat panel displays such as LCD, TFT, or plasma displays as well as the older CRT displays.

The functionality of the invention, particularly the detection of the pointing position of the light pen may be performed by hard- or software. In case of an implementation in software, a single or multiple standard microprocessors or microcontrollers may be used to process a single or multiple algorithms implementing the invention.

It should be noted that the word “comprise” does not exclude other elements or steps, and that the word “a” or “an” does not exclude a plurality. Furthermore, any reference signs in the claims shall not be construed as limiting the scope of the invention.

1. A light pen input system (10) comprising
a light pen (12) being adapted to generate at least one scanning light line (14, 15) sweep for scanning a surface (16),
a light sensing element (18) placed at a known position for detecting a scanning light line (14, 15),
time measurement means (20) being adapted to measure a time duration t−tₛₜₐᵣₜ from receiving a scanning start signal until receiving a light detection signal from the light sensing element (18), and
position detection means (22) being adapted to determine the coordinates of the pointing position of the light pen (12) with regard to the surface (16) from measured time durations t−tₛₜₐᵣₜ.

2. System according to claim 1, wherein
the light pen (12) is adapted to generate two scanning light line (14, 15) sweeps for scanning the surface (16) in two different directions.

3. system according to claim 2, wherein
the two scanning light lines (14, 15) generated by the light pen (12) have different wavelengths.

4. System according to claim 2, wherein one (14) of the two scanning light lines is moved in a first direction (26), and the other one (15) of the two scanning light lines is moved in a second direction (27) which is orthogonal to the first direction (26).

5. System according to claim 4, wherein the position detection means (22) are adapted to determine a x-coordinate of the pointing position of the light pen (12) from a measured time duration tx−txₛₜₐᵣₜ triggered from the scanning light line (14) sweep in the first direction (26) and a y-coordinate of the pointing position of the light pen (12) on the surface (16) from a measured time duration ty−tyₛₜₐᵣₜ triggered from the scanning light line (15) sweep in the second direction (27).

6. System according to claim 4, wherein the position detection means (22) are adapted to determine a movement of the light pen (12) from at least two consecutive measured time durations t0−t0ₛₜₐᵣₜ and t1−t1ₛₜₐᵣₜ.

7. System according to claim 1, wherein the light pen (12) is adapted so that the time duration of a scanning light line sweep is about 1 to 100 milliseconds, preferably 5 to 10 milliseconds.

8. System according to claim 1, wherein the angular velocity of movement of a generated scanning light line (14, 15) is nearly constant and predefined.

9. System according to claim 1, wherein a second a light sensing element (19) being aligned to the first a light sensing element (18) is provided, wherein the time measurement means (20) are adapted to measure a first time duration t1−tₛₜₐᵣₜ from receiving a scanning start signal until receiving a light detection signal from the first light sensing element (18) and a second time duration t2−tₛₜₐᵣₜ from receiving the scanning start signal until receiving a light detection signal from the second light sensing element (18), and the position detection means (22) are adapted to determine a skew of the light pen (12) with regard to the surface (16) from the first and second measured time durations.

10. System according to claim 9, wherein the surface (16) has a rectangular or quadratic shape and both light sensing elements (18, 19) are located in opposite corners of the surface (16), and wherein the position detection means (22) are further adapted to determine the size of the surface (16) from the first and second measured time durations, store the determined size, and use the determined size for the determination of the coordinates of the pointing position of the light pen (12) with regard to the surface (16).

11. System according to claim 1, wherein the light sensing element (18) is located at a border or corner of the surface (16), integrated into, located underneath, besides or in front of the surface.

12. A light pen (12) being adapted for use with a system according to claim 1 and comprising at least one laser (38) and optical means (40, 42, 44, 46, 48) for generating two scanning light lines (14, 15).

13. The light pen according to claim 12, wherein it comprises two lasers capable of generating laser beams with different wavelengths.

14. The light pen according to claim 12, wherein it comprises one laser (38) and the optical means comprise a beam splitter (40) for splitting the laser beam generated by the laser (38) into two laser beams

15. The light pen according to claim 12, wherein the optical means comprise a first barrel lens (42) for creating a vertical scanning light line, a second barrel lens (44) for creating a horizontal scanning light line, a first movable mirror (46) for sweeping the vertical scanning light line over a predefined area, and a second movable mirror (48) for sweeping the horizontal scanning light line over a predefined area.

16. The light pen according to claim 12, wherein it is adapted for transmitting a scanning start or synchronization signal to the time measurement means (20).

17. The light pen according to claim 12, wherein it is adapted for receiving a scanning start or synchronization signal from the time measurement means (20) or the position detection means (22).

18. Display screen unit comprising a light pen input system according to claim 1.

19. Display screen unit comprising a light pen input system (10), the light pen system (10) comprising
a light pen (12) being adapted to generate at least one scanning light line (14, 15) sweep for scanning a surface (16),
a light sensing element (18) placed at a know position for detecting a scanning light line (14, 15),
time measurement means (20) being adapted to measure a time duration t−tₛₜₐᵣₜ from receiving a scanning start signal until receiving a light detection signal from the light sensing element (18), and
position detection means (22) being adapted to determine the coordinates of the pointing position of the light pen (12) with regard to the surface (16) from measured time durations t−tₛₜₐᵣₜ, further comprising a communication interface adapted for communicating with a light pen comprising at least one laser (38) and optical means (40, 42, 44, 46, 48) for generating two scanning light lines (14, 15).

20. Display screen unit according to claim 18, further comprising processing means for controlling the position of a cursor displayed on the display screen of the display screen unit based on the coordinates of the pointing position of the light pen determined by the position detection means of the light pen input system.

21. Display screen unit according to claim 18, wherein the first light sensing element is located at the border of the display screen and the unit comprises the time measurement and position detection means.

22. Display screen unit according to claim 18, wherein the display screen is a LCD, TFT, or plasma display.

23. A bar being adapted for use with a system according to claim 1, wherein the bar comprises photodiodes on each edge for detecting a scanning light line.

24. A method for determining the pointing position of a light pen (12), wherein
the light pen (12) generates at least one scanning light line (14, 15) sweep for scanning a surface (16),
a light sensing element (18) located at a border of the surface (16) detects a scanning light line (14, 15),
time measurement means (20) measure a time duration t−tₛₜₐᵣₜ from receiving a scanning start signal until receiving a light detection signal from the light sensing element (18), and
position detection means (22) determine the coordinates of the pointing position of the light pen (12) with regard to the surface (16) from measured time durations t−tₛₜₐᵣₜ.
